(19) United States
(12) Patent Application Publication
(10) Pub. No.: US 2006/0174842 A1
(43) Pub. Date: Aug. 10, 2006

(54) Shampooing device

(76) Inventors: Aritee Poletis Bond, Reisterstown, MD (US); Ralph W. Brindle, Pylesville, MD (US); Andy C. Retzlaff, Glen Rock, PA (US)

Correspondence Address: Armstrong Kratz Quintos;Hanson & Brooks, Suite 220, 502 Washington Avenue, Towson, MD, 21204, US

(21) Appl. No.: 10/548,145

(22) PCT Filed: Mar. 2, 2004
(86) PCT No.: PCT/US04/06184

§ 371 Date: Sep. 6, 2005

(51) Int. Cl. A01K 13/00

(52) U.S. Cl. 119/664

(57) ABSTRACT

A shampooing tool has a “clam-shell” design for trapping the components of the tool between the complementary mating halves of the housing. The components include a barrel disposed in the upper portion of the housing and connected to a pressurized water source, a trigger depending from an enclosed hand grip, a normally-closed spring-loaded valve disposed in the front portion of the housing and connected to the trigger for movement in unison, and a cylinder within the lower part of the housing, the cylinder having a pressurized liquid detergent and further having a discharge port leading to a valve seat. When the trigger is depressed, the valve is unseated; and the liquid detergent, under pressure, flows into a tube running substantially parallel to the barrel. A shampooing head on the end of the barrel has first and second orifices connected to the barrel and to the tube, respectively; and the respective first and second orifices are independent of each other and are arranged intermediately of the bristles on the shampooing head. The tool may have a conduit connected to an external reservoir of detergent. The reservoir may be in a backpack having a pump powered by a battery energized motor.

### FIELD OF THE INVENTION

The present invention relates to a shampooing tool and, in particular, to a shampooing tool for dogs, horses and other animals.

### BACKGROUND OF THE INVENTION

In the prior art, of which we are aware, various handheld shampooing tools have been disclosed for use on building structures, cars and pets. However, these prior art disclosures leave much to be desired, especially for use with humans, dogs, horses and/or other animals; and, indeed, I am not aware of any practical commercial product currently on the market which is intended, primarily, for shampooing humans, dogs, horses and/or other animals.

For example, in scrubbing a dog by hand with (or without) the use of a sponge, and in maintaining control of the dog, it is necessary to continually or repeatedly bend one's body or stoop over the dog; and as a result, scrubbing and rinsing the dog becomes a real chore which is very tiresome and, frequently, results in aggravating back pains or other joint or muscular strains. Additionally, the prior art devices often aspirate the liquid soap out its reservoir by means of the water flow under pressure, and this process tends to quickly use up the reservoir of soap; hence is wasteful and undesirable.

Market research has shown that there are roughly 50,000,000 dogs and 4,000,000 horses in the United States alone, besides the potential for world-wide sales; yet despite this critical need, no practical ergonomically-designed shampooing tool currently exists on the market for grooming dogs, nor has the versatility to groom dogs, horses and/or other animals.

Moreover, the prior art devices tend to be cumbersome and complicated; and even if relatively simple (such as a handheld tool for washing cars) the prior art devices are not well suited for the particular environment or application to a human, dog, horse and/or other animal.

Also, people in nursing homes and ill people who cannot wash themselves, or can do so only with difficulty, need a handheld device which can be used by another person to more effectively wash the ill or elderly person.

### SUMMARY OF THE INVENTION

Accordingly, it is an object of the present invention to alleviate the disadvantages and deficiencies of the prior art by providing a compact, lightweight well-balanced sturdy shampooing tool, one which is ergonomically designed and hence convenient and easy to use and control, and one which is well suited for use on a human, dog, horse or other animal.

It is another object to the present inventor to provide a tool which will enable the owner, while seated, to shampoo his or her dog, thereby avoiding potentially-disabling back or other health problems; yet will allow the same shampooing tool to be used in a normal standing position while grooming a horse.

It is yet another object of the present invention to provide a shampooing tool which has an elegant design, one which may be manufactured in high volume and at relatively low cost, and thus may be merchandised and promoted through various channels of marketing and distribution.

It is a further object of the present invention to provide a shampooing tool wherein the water flow and the discharge of the liquid detergent are completely independent of each other, such that use of the liquid detergent is metered, thereby improving the operator's control of the tool while conserving the use of the liquid detergent or other soap.

In accordance with the teachings of the present invention, a shampooing tool is herein disclosed which includes a housing having an upper portion forming a hand grip for the tool, the hand grip being provided with a trigger. The housing includes a lower portion having a cylinder provided with a reservoir of liquid detergent under pressure, and the housing further includes a front portion connecting the respective upper and lower portions of the housing. A spring-loaded normally-closed valve is disposed within the front portion of the housing, and the valve closes a valve seat connected to the pressurized reservoir of liquid detergent. The valve is connected to the trigger for movement in unison; such that when the trigger is actuated, the valve is unseated and liquid detergent passes through the valve seat, around the valve, and through a discharge port in the front portion of the housing. A tube is connected to the discharge port and projects forwardly alongside a barrel. The barrel is disposed in the upper portion of the housing, and the barrel has a rearward portion adapted to be connected to a pressurized water source. A shampooing implement is carried on the forward ends of the barrel and tube, respectively.

In a particular embodiment of the present invention, the housing has a pair of complementary mating halves joined together along a common longitudinal midplane. The trigger, valve and cylinder are mounted in one of the mating halves of the housing; and the other mating half of the housing comprises a cover secured to the one mating half, thereby trapping the trigger, valve and cylinder within the housing.

Preferably, the trigger includes an integrally-molded rib portion slidably mounted between respective pairs of lands formed in the one mating half of the housing. The valve has an integrally-molded stem projecting upwardly in the housing; and the stem, in turn, has a slot formed therein for receiving a forwardly-extending integrally-molded portion of the trigger.

In the preferred embodiment, a piston is mounted for slidable movement within the cylinder; rearwardly of the reservoir, and the piston is connected by a lanyard to an end cap. The end cap is threaded on to a portion of the cylinder projecting rearwardly of the housing. A coil spring surrounds the lanyard (radially thereof) and the coil spring is disposed within the cylinder for “free-floating” axial movement therein. One end of the coil spring is seated within the piston, and the other end of the coil spring is seated within the end cap. When the reservoir is filled, and when the end cap is secured on the cylinder, the coil spring is axially compressed within the cylinder, thereby pressuring the reservoir of liquid detergent within the cylinder. The cylinder also has a forward opening in communication with the reservoir of liquid detergent, and an internal tube is disposed within the housing and connects the valve seat to the forward opening on the cylinder.

Preferably, the housing has a rearward portion connecting the respective upper and lower portions of the housing, such that the hand grip is fully enclosed. Moreover, the upper portion of the housing is provided with curved finger indentations projecting into the fully-enclosed hand grip, and these curved finger indentations are disposed rearwardly of the trigger.

Viewed in another aspect, the shampooing tool of the present invention includes a housing forming a hand grip for the tool, and a trigger is disposed within the hand grip. The trigger has an integrally-molded rib portion slidably mounted within the housing, and the trigger further has a forwardly-extending integrally-molded portion disposed substantially perpendicularly of the rib portion of the trigger. A valve is disposed within the housing, and the valve has an upwardly-extending stem portion provided with a slot for receiving the forwardly-extending portion of the trigger, such that the trigger and valve move in unison.

In another aspect of the present invention, with the piston connected to the end cap by the lanyard, with the coil spring seated between the piston and the end cap, and with the spring thus “trapped” by the lanyard, the piston, end cap, lanyard and spring form a subassembly, This subassembly may be removed from the rearwardly-extending portion of the cylinder, and liquid detergent may then be poured into the cylinder to provide the reservoir. The subassembly is then re-inserted into the cylinder, and the end cap is tightened on the rearwardly-extending portion of the cylinder, thereby providing a pressurized reservoir of liquid detergent within the cylinder.

The present invention also constitutes the method of shampooing a human, dog, horse or other animal, wherein the liquid detergent (the soap) and the water flow are independently controlled by the operator of the tool. This method comprises the steps of providing a shampooing tool having a trigger within an enclosed hand grip on the tool, the tool further having a valve closing off a valve seat connected to a pressurized source of liquid detergent disposed within a lower portion of the housing. The tool further has a barrel disposed in an upper portion of the housing, and the barrel has a forward portion connected to a shampooing implement and further has a rearward portion connected to a pressurized water supply through a control means. The control means is released to allow water to soak the human, dog, horse or other animal. The trigger is actuated to unseat the valve from its valve seat, such that the liquid detergent under pressure mixes with the water flow. Alternately, the human, dog, horse or other animal may be “soaked” first with the water flow while the soap is turned “off” (the trigger not being actuated) and thereafter, the water flow turned “off” by the control means, and the trigger actuated to “soap up” the animal, using the water already on the animal. The shampooing head is then manually manipulated to scrub down the human, dog, horse or other animal. Then, with the trigger not being actuated, and with the control means on the barrel in an open position, the human, dog, horse or other animal is rinsed off, thereby conveniently providing a “soap”, “scrub” and “rinse” cycle, respectively.

Since the water flow and dispensing of the liquid detergent (the soap) are manually controllable, independently of each other, the soap may be metered under full operator control for economical usage of the shampooing tool. Moreover, the intensity of the water flow may be easily adjusted by the operator.

In another embodiment of the present invention, the cylinder has a portion accessible externally of the housing; and a pre-packaged disposable cartridge, filled with a liquid detergent under pressure, is inserted through the externally-accessible portion of the cylinder and engages a needle within the cylinder, thereby rupturing a frangible seal on the cartridge. The cylinder has a discharge port in fluid communication with the needle for flow of the pressurized liquid detergent out of the ruptured cartridge in the cylinder. Preferably, the cartridge has an internal propellant for pressurizing the liquid detergent.

In this embodiment, a closure means is provided for the externally-accessible portion of the cylinder, and the closure means resiliently biases the cartridge forwardly of the cylinder and into engagement with the needle on the cylinder. Preferably, the closure means includes an internally-threaded end cap, and the externally-accessible portion of the cylinder is externally threaded to receive the internally-threaded end cap. The end cap carries a spring engaging a rearward portion of the cartridge, thereby resiliently biasing the cartridge forwardly to engage the needle in the cylinder.

In each embodiment, the respective end cap may be removed and replaced by a suitable coupling through a hose to a pressurized tank of liquid detergent.

Viewed in yet another aspect, the present invention provides a shampooing tool which includes a barrel connected to a pressurized water supply. A tube is connected to a pressurized source of liquid detergent, the tube running substantially parallel to the barrel. The barrel and tube have respective forward ends connected to a shampooing head. This shampooing head has a first orifice (or first set of orifices) in fluid communication with the barrel and the pressurized water supply; and the shampooing head further has a second orifice (or second set of orifices) in fluid communication with the pressurized source of liquid detergent, the respective first and second orifices being independent of each other. Preferably, the shampooing head has downwardly-projecting bristles intermediately of the respective first and second orifices.

Preferably, a first control means is provided for the water flow, and a second control means is provided for the flow of liquid detergent through the shampooing head. The second control means comprises a trigger which is actuated to selectively unseat a normally-closed spring-loaded valve connecting the tube to the pressurized source of liquid detergent in the housing.

In further accordance with the teachings of the present invention, there is disclosed a shampooing tool, having a housing including an upper portion forming a hand grip for the tool. The hand grip is provided with a trigger. The housing further includes a lower portion having a conduit connected to an external reservoir of liquid detergent under pressure. The housing further has a front portion connecting the respective upper and lower portions of the housing. A spring-loaded normally-closed valve is disposed within the front portion of the housing, the valve seating against a valve seat connected through the conduit to the pressurized reservoir of liquid detergent. The valve is coupled to the trigger for movement in unison; such that when the trigger is actuated, the valve is unseated and liquid detergent passes through the conduit, past the valve seat, around the valve, and through a discharge port in the front portion of the housing. A tube is connected to the discharge port and projects forwardly of the housing. A barrel in the upper portion of the housing has a rearward portion adapted to be connected to a pressurized water source. A shampooing implement is connected to the forward ends of the barrel and tube, respectively.

Additionally, there is disclosed a shampooing tool having a housing including a pair of complementary mating sections joined together along a common longitudinal midplane. The housing further includes an upper portion forming a fully-enclosed hand grip for the tool. The hand grip is provided with a trigger and is further provided with curved finger indentations rearwardly of the trigger. The housing further includes a lower portion provided with a conduit connected to an external reservoir of liquid detergent. The external reservoir of liquid detergent has a backpack having a pump driven by a motor powered by a rechargeable battery. The housing further has a front portion between the respective upper and lower portions of the housing. A spring-loaded normally-closed valve is disposed within the front portion of the housing. The valve has a conical tip seating against a valve seat. The conduit has a forward end connected to the valve seat. The trigger has an integrally-molded rib portion slidably mounted between respective pairs of lands formed in one of the mating sections of the housing. The trigger further has a forwardly-extending integrally-molded portion. The valve has an integrally-molded stem projecting upwardly thereof. The stem has a slot formed therein and receives the forwardly-extending integrally-molded portion of the trigger, thereby connecting the trigger to the valve for movement in unison. When the trigger is actuated, the valve is unseated and liquid detergent under pressure passes through the conduit, around the valve seat, through the valve, and through a discharge port in the front portion of the housing. A barrel is disposed in the upper portion of the housing, the barrel having a rearward portion adapted to be connected to a pressurized water source. Means are provided for controlling the flow of water through the barrel. A tube is disposed externally of the housing. The tube is connected to the discharge port in the front portion of the housing and runs therefrom substantially parallel to and along side of the barrel. A shampooing implement is mounted on the respective forward ends of the barrel and tube; such that the water flow and the flow of the liquid detergent are independent of each other, thereby conserving the use of the liquid detergent. Also, the trigger, valve, barrel and cylinder are mounted in one of the mating sections of the housing; and the other mating section of the housing comprises a cover secured to the one mating section.

In another aspect, there is disclosed in combination with a handheld portable shampooing tool for sequentially soaking, washing and rinsing purposes as desired by an operator of the tool, the tool has a first valve means for controlling an external pressurized water source connected to the tool. The tool further has a second valve means for controlling an external pressurized reservoir of liquid detergent. The second valve means is activated by a trigger carried by a handgrip portion of the tool, and the external pressurized reservoir of liquid detergent is disposed in a backpack carried by the operator.

There is further disclosed in combination, a handheld portable shampooing tool. The tool has a housing including a handgrip portion. The housing has an upper rearward portion connected to a pressurized water source for discharge of water forwardly of the tool. The tool further has a lower rearward portion connected to an external pressurized source of liquid detergent for discharge of the detergent forwardly of the tool, and a trigger within the handgrip portion of the housing for controlling the flow of liquid detergent independently of the water flow.

Additionally, there is disclosed a portable self-contained shampooing apparatus, having a handheld housing including a lower portion connected by a conduit to a pressurized reservoir of liquid detergent contained in a backpack. The housing includes a handgrip portion provided with a trigger for controlling the discharge of the liquid detergent though a tube extending forwardly of the housing. The housing further includes an upper portion connected to a pressurized water source for discharge of the water through a barrel extending forwardly of the housing. The barrel and tube terminate in respective ends, and a shampooing implement is mounted on the respective ends of the barrel and tube.

These and other objects of the present invention will become apparent from a reading of the following specification, taken in conjunction with the enclosed drawings.

### BRIEF DESCRIPTION OF THE DRAWINGS

FIG. 1 is a pictorial view of one embodiment of the shampooing tool being used on a dog. In this case, a golden retriever is being rinsed off, while the dog's owner (or other operator) is comfortably seated in a chair.

FIG. 2 is a further pictorial view, showing the shampooing tool of the present invention being used to soak down (or soap up) a horse, in which case the operator is standing in a normal, comfortable position.

FIG. 3 is an enlarged longitudinal cross-section of the shampooing tool of FIG. 1, and in particular the housing portion thereof.

FIG. 4 is an exploded perspective view of the subassembly comprising the piston, end cap, lanyard and coil spring (the subassembly being removably received in the cylinder, and the cylinder being retained within the shampooing tool of the present invention).

FIG. 5 is a detailed cross-section, taken along the lines 5-5 of FIG. 3, showing a cylinder in the lower portion of the housing, and further showing a piston slidably received in the cylinder. In this view, the liquid detergent has been fully used up, and the piston is all the way down in the cylinder.

FIG. 6 is a further cross-sectional view, corresponding substantially to FIG. 5, but showing a reservoir of liquid detergent forwardly of the piston in the cylinder, and further showing the piston substantially fully retracted rearwardly in the cylinder. In this view, the spring is compressed to exert a resilient bias on the piston, thereby pressing on the piston to pressurize the liquid detergent in the cylinder.

FIG. 7 is an elevational view of the lower portion of the housing, showing a slot having a window in the housing for viewing the level of liquid detergent remaining in the cylinder.

FIG. 8 is a cross-section thereof taken along the lines 8-8 of FIG. 7, enlarged in scale, and showing the window and the cylinder (both of which are transparent).

FIGS. 9-12 are pictorial sequence views, showing the manner in which the liquid detergent is poured into the cylinder.

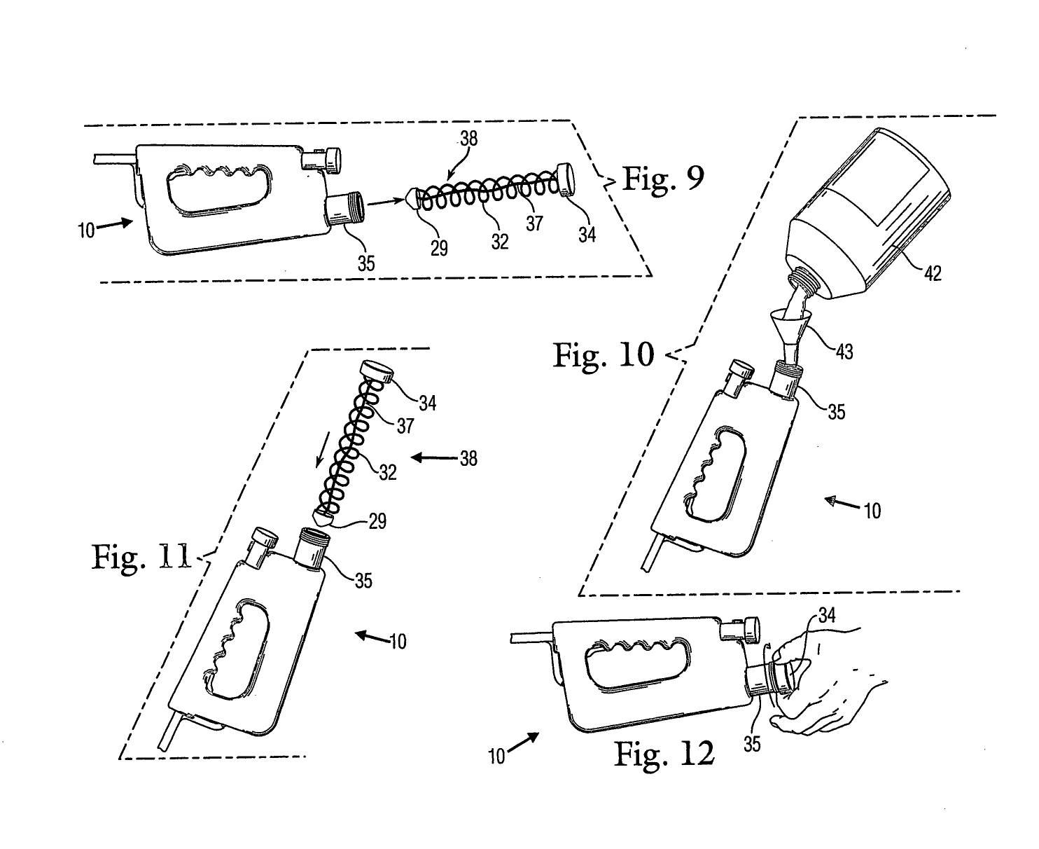

In FIG. 9, the subassembly of an end cap, spring and piston has been removed from the cylinder in the lower portion of the housing.

In FIG. 10, the liquid detergent is being poured through a funnel into the cylinder in the housing, thereby providing a reservoir of liquid detergent in the housing.

In FIG. 11, the subassembly of the end cap, spring, lanyard and piston has been inserted, partially, into the cylinder.

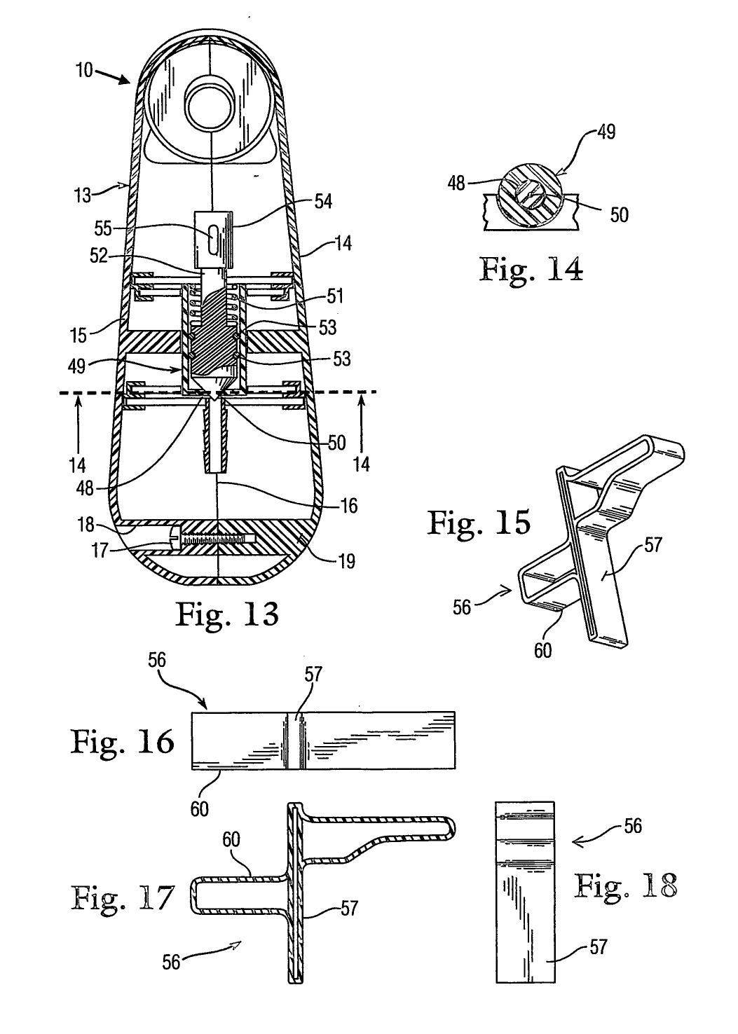

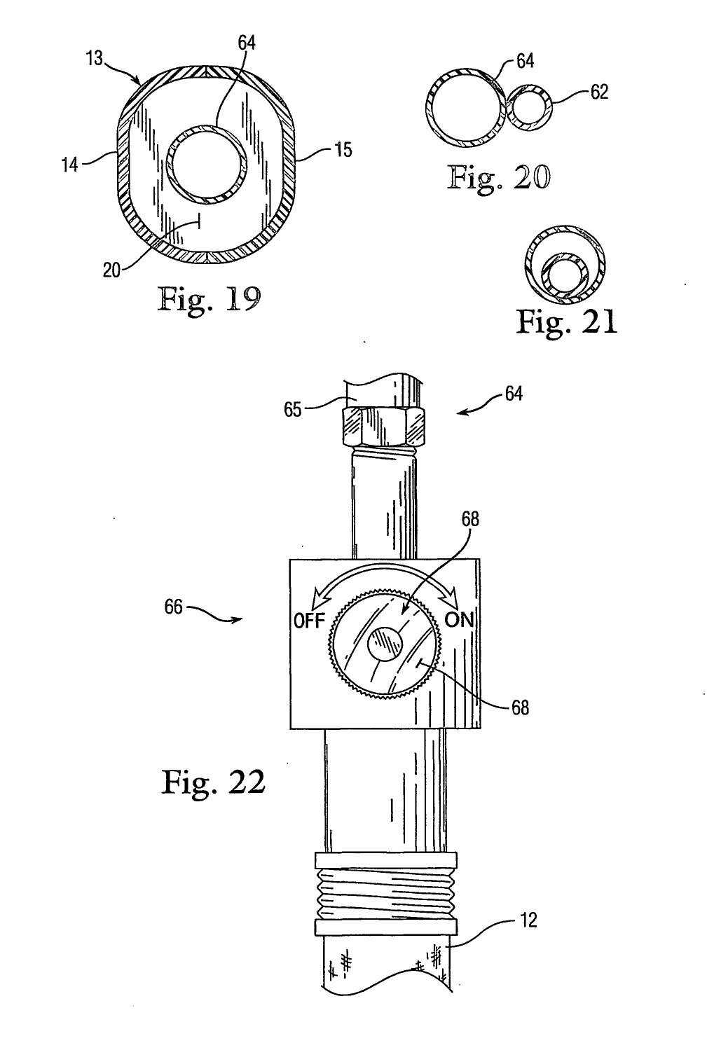

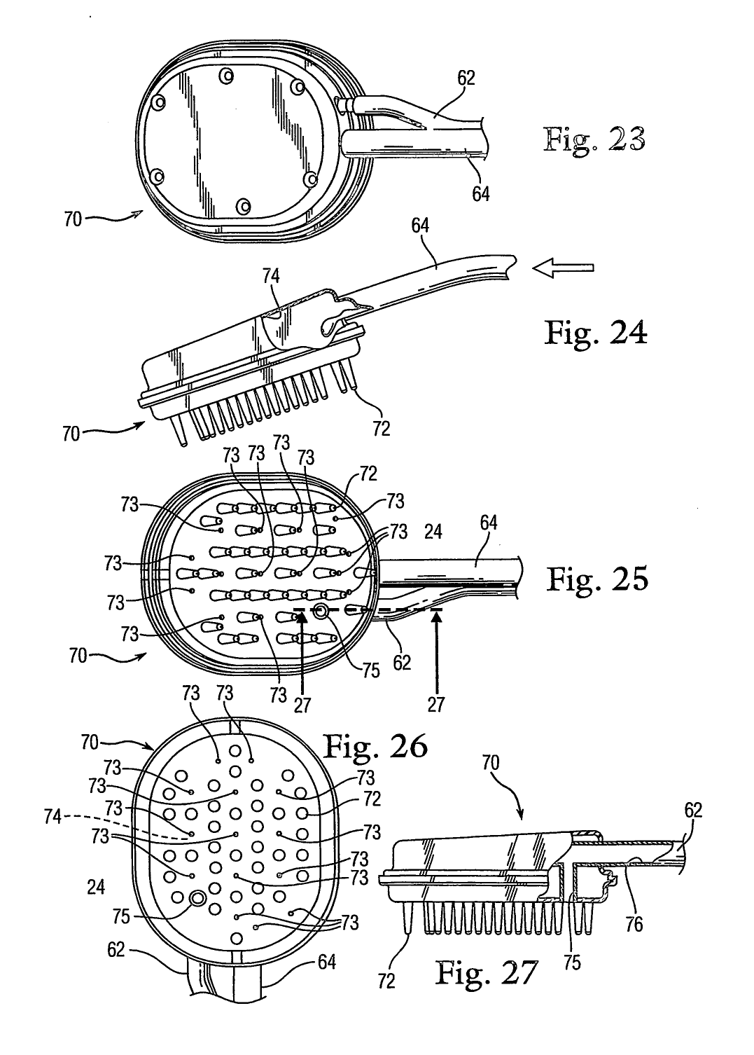

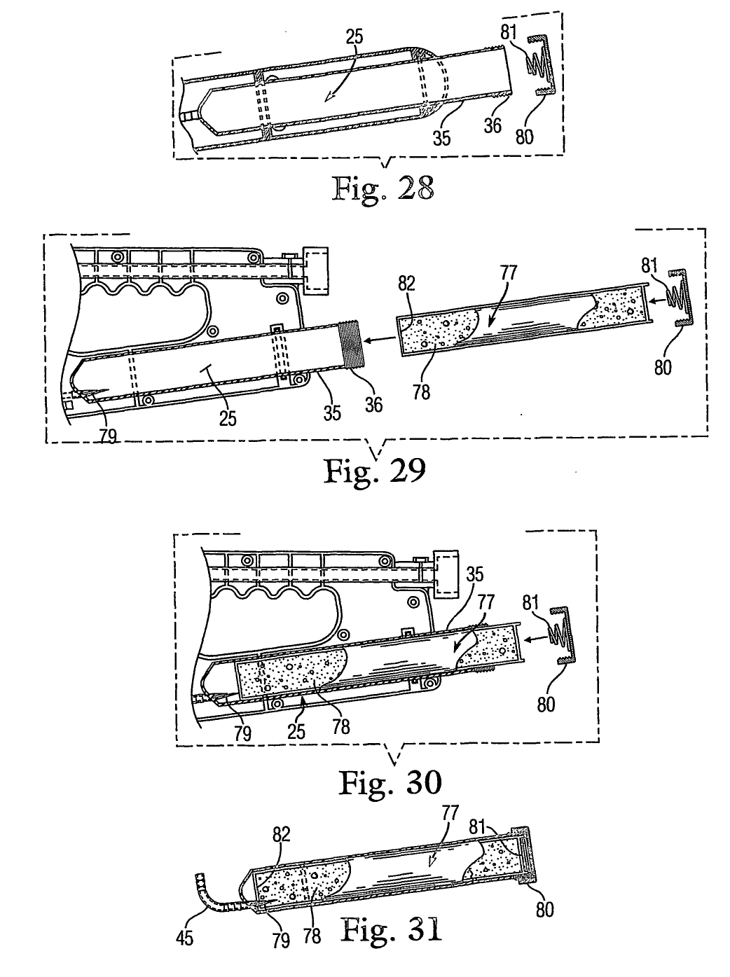

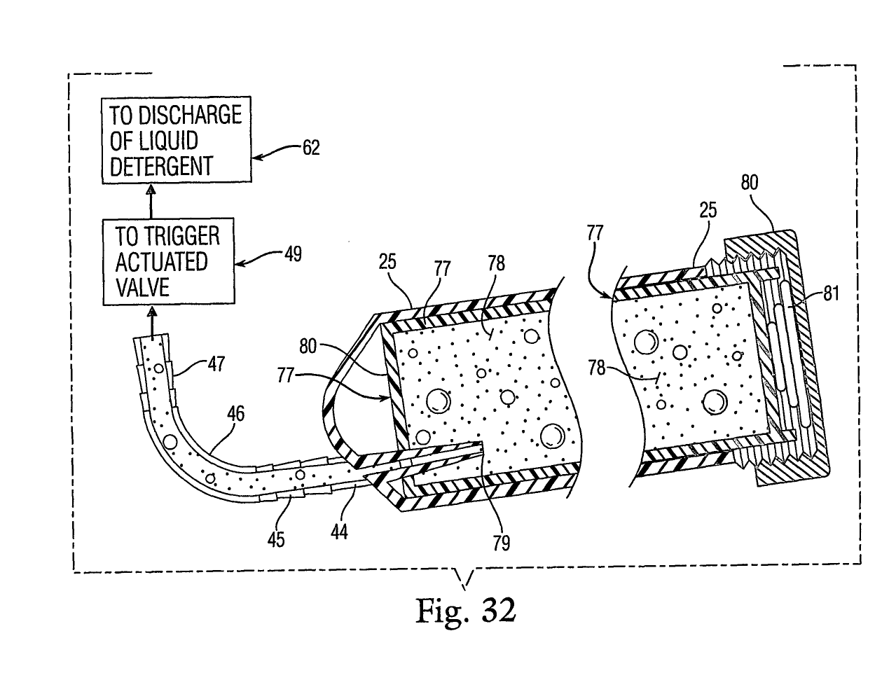

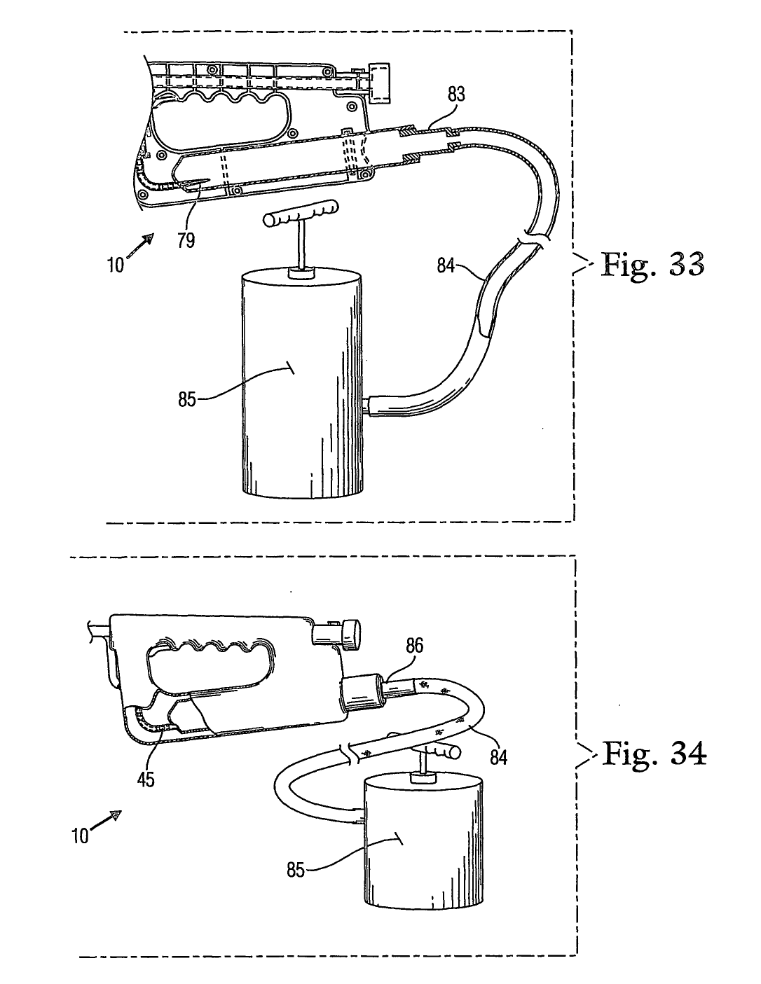

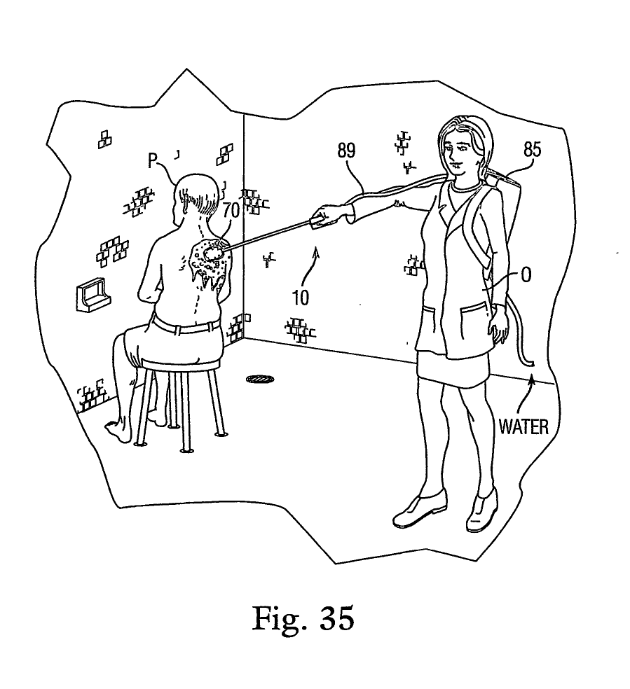

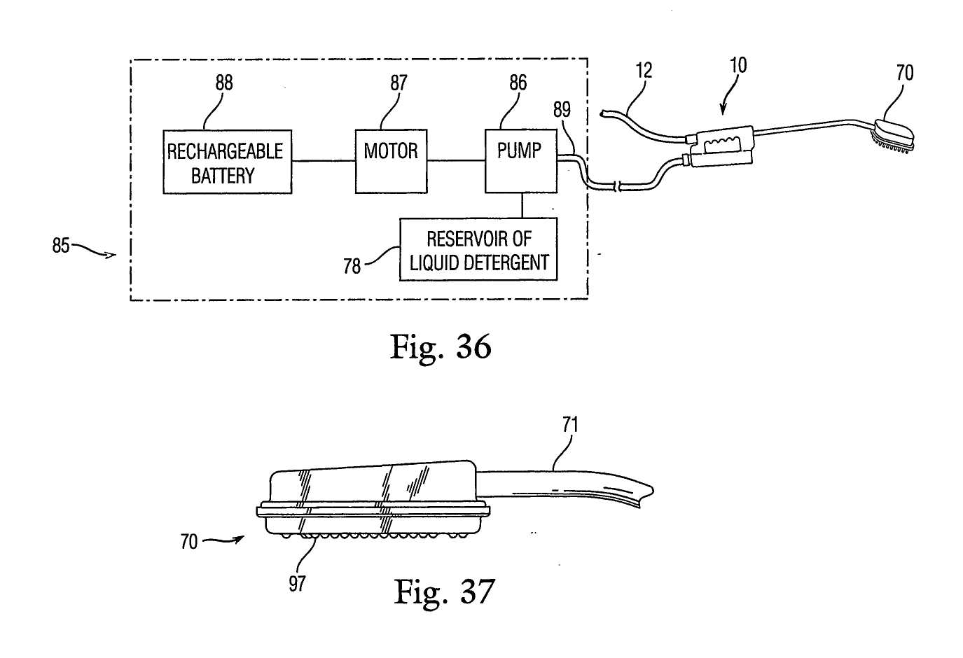

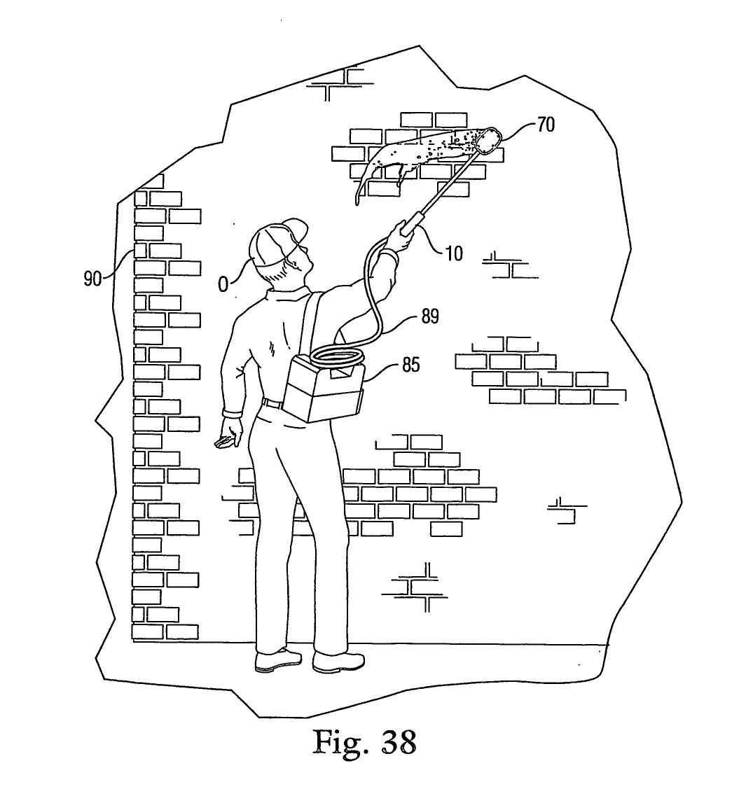

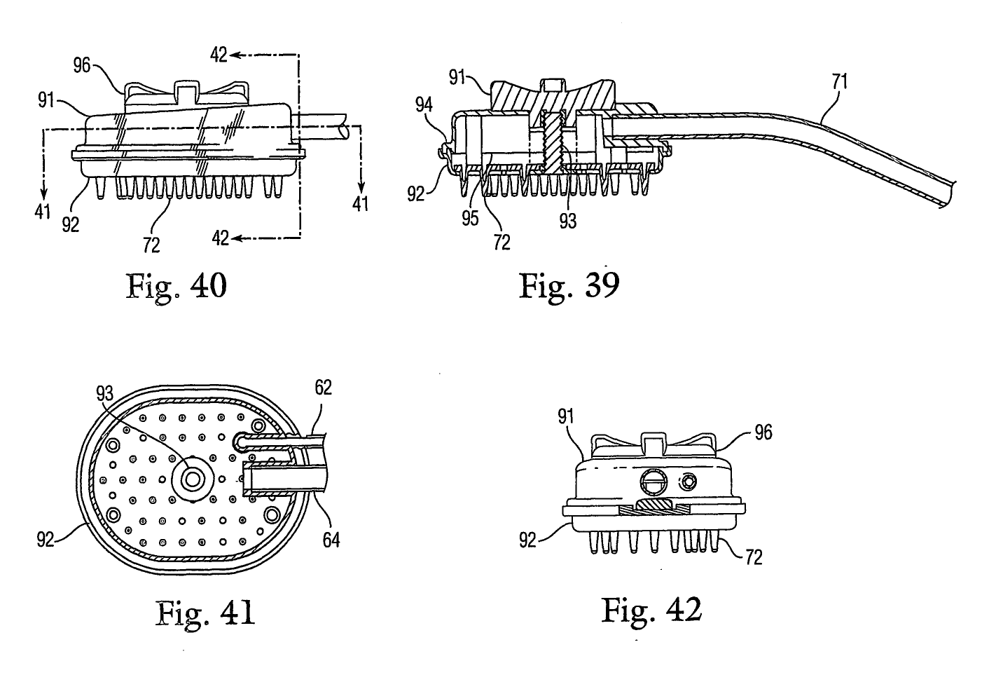

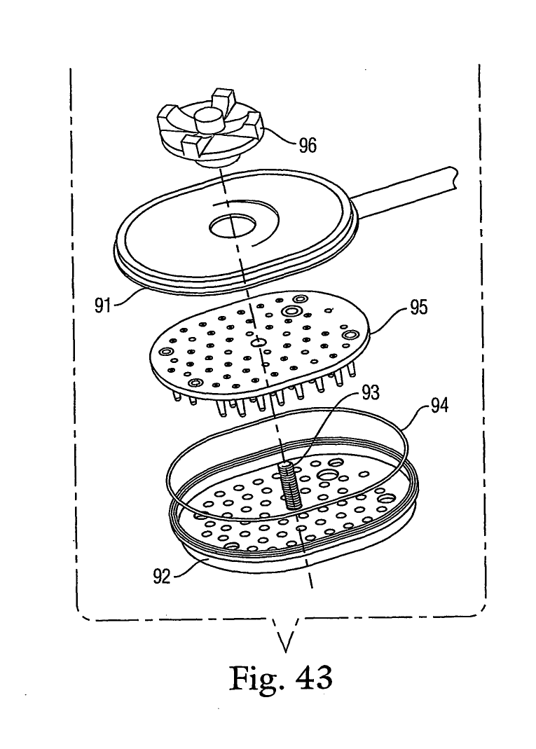

In FIG. 12, the end cap has been tightened on the cylinder to thereby compress the spring (and through the spring to resiliently bias the piston) to pressurize the reservoir of liquid detergent in the housing.

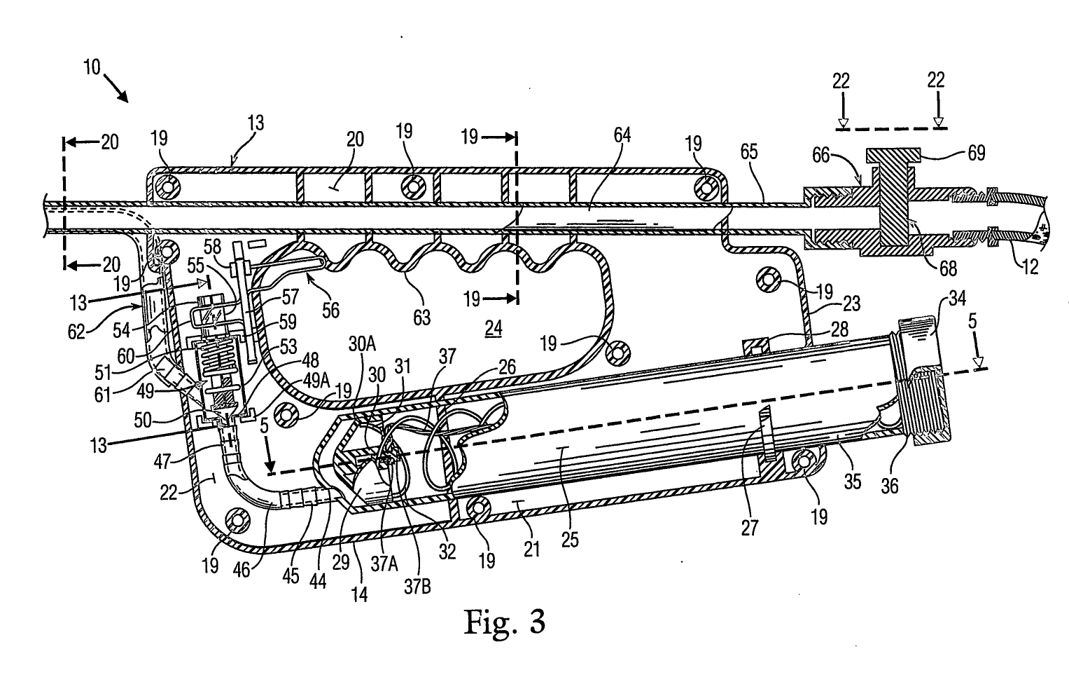

FIG. 13 is a cross-section, taken along the lines 13-13 of FIG. 3, and showing the valve assembly in a front portion of the housing for the shampooing tool.

FIG. 14 is a cross-sectional view thereof, taken along the lines 14-14 of FIG. 13, and showing the valve seat.

FIG. 15 is a perspective view of the integrally-molded trigger.

FIG. 16 is a top plan view thereof.

FIG. 17 is an elevational view thereof.

FIG. 18 is an end view thereof.

FIG. 19 is a cross-section of the barrel of the shampooing tool, taken along the lines 19-19 of FIG. 3.

FIG. 20 is a further cross-section of the barrel, taken forwardly of the tool and along the lines 20-20 of FIG. 3, and showing the tube for flow of the pressurized liquid detergent, the tube running substantially parallel to the barrel and both terminating in a shampooing head.

FIG. 21 is a cross-section of the barrel taken forwardly of the tool and along the lines 20-20 of FIG. 3 showing an alternate embodiment with the tube disposed within the barrel.

FIG. 22 is a top plan view of a control valve on a rearwardly-projecting portion of the barrel for controlling the water flow, the view being taken along the lines 22-22 of FIG. 3.

FIG. 23 is a top plan view of a preferred shampooing head on the tool (the head being tilted).

FIG. 24 is a side elevational view thereof (the shampooing head being substantially hollow and in communication with the water flow through the barrel).

FIG. 25 is a bottom plan view thereof (again, the head being tilted, FIG. 23).

FIG. 26 is a full bottom plan view of the shampooing head.

FIG. 27 is a cross-section, taken along the lines 27-27 of FIG. 25, and showing a canal or passageway for flow of the pressurized liquid detergent, intermediately of the bristles.

FIG. 28 is a partial elevational view of another embodiment of the present invention showing an end cap (with a suitable spring attached thereto) removed from the tool. In this embodiment, the piston has been eliminated.

FIG. 29 corresponds substantially to FIG. 28, but shows the end cap and a pre-packaged disposable cartridge in exploded relationship to the tool, the cartridge having a pressurized liquid detergent contained therein.

FIG. 30 corresponds substantially to FIG. 29, but shows the cartridge inserted into the cylinder, and further showing the forward portion of the cylinder engaging a needle within the housing.

FIG. 31 corresponds substantially to FIG. 30, but shows the needle in the cylinder piercing the seal on the cartridge as the end cap (preferably knurled or grooved) is tightened on the rearwardly-extending portion of the cylinder.

FIG. 32 is an enlarged portion of FIG. 31, showing the end cap fully tightened, the spring (which in this case, is carried by the end cap) being compressed, and showing the needle fully piercing or rupturing the seal on the cartridge. In this view, the needle is connected to a trigger-actuated valve for flow of the pressurized liquid detergent to the shampooing head. These latter mechanisms are shown schematically, but could be similar to those in FIG. 3.

FIG. 33 is a pictorial view of the shampooing tool of FIG. 32, wherein the disposable cartridge is not used, wherein the end cap has been removed and replaced with a suitable coupling, and wherein the coupling is connected to a hose leading to a pressurized (external) tank of liquid detergent.

FIG. 34 is a further pictorial view, wherein the end cap of FIG. 3 is removed, and wherein an interchangeable coupling means is substituted for the end cap, the interchangeable coupling means coupling the reservoir in the housing to a pressurized tank of liquid detergent disposed externally of the tool.

FIG. 35 is a perspective view of one embodiment of the shampooing tool worn in a backpack and being used on a human.

FIG. 36. is a diagrammatic view of the backpack connected to the shampooing tool.

FIG. 37 is a side elevation view of the shampooing tool used on humans showing a plurality of bubbles on the surface.

FIG. 38 is a perspective view of the shampooing device used for cleaning a wall.

FIG. 39 is a partial cross-section, side elevation view of the shampoo head connected to the tube and barrel.

FIG. 40 is a side elevation view of the shampoo head.

FIG. 41 is a cross-section view taken across the lines 41-41 of FIG. 40.

FIG. 42 is a cross-section view taken across the lines 42-42 of FIG. 40.

FIG. 43 is an exploded view of the shampoo head.

### GENERAL DESCRIPTION OF THE PREFERRED EMBODIMENTS

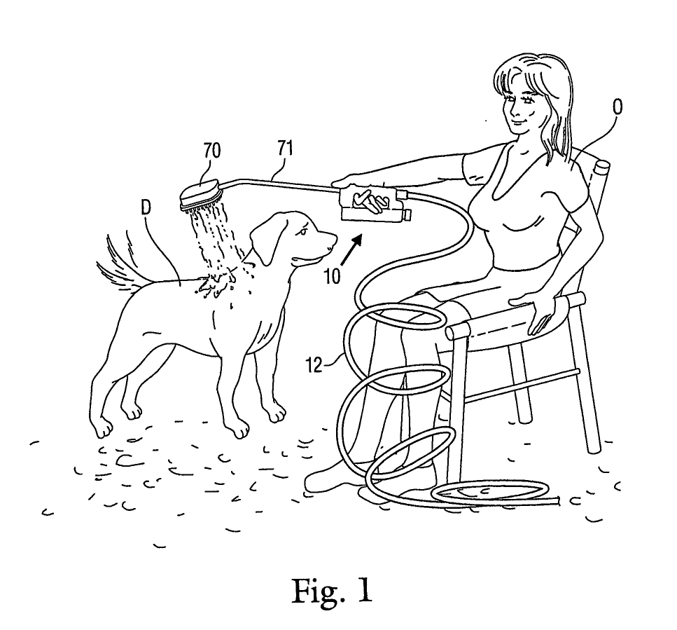

With reference to FIG. 1, there is illustrated the shampooing tool 10 of the present invention being used on a dog D by its owner O (or by the operator O of the tool 10). As shown, the dog D is getting pre-soaked (or rinsed off) by use of the tool 10 while the owner (or operator O) is comfortably seated in a chair. In this example, the dog D is a golden retriever; however, it will be appreciated by those skilled in the art that the shampooing tool 10 of the present invention may be used on other dogs and/or other animals, as for example, horses.

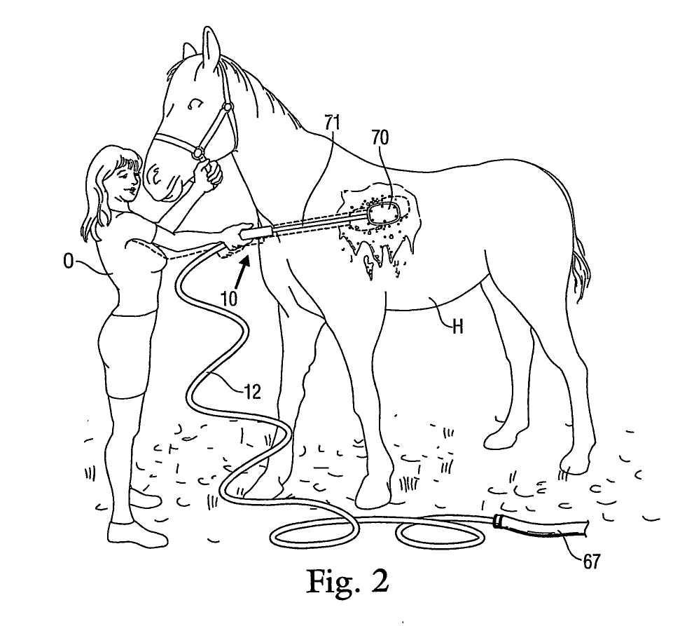

Indeed, with reference to FIG. 2, the tool 10 is being used to scrub down a horse H while the owner (operator) O is standing normally, not crouching nor bending. This illustrates the ergonomic improvement as well as the widespread versatility of the shampooing tool 10 of the present invention.

Besides, its widespread application and versatility, it will be appreciated by those skilled in the art that the shampooing tool 10 of the present invention is easy, quick and convenient to use. In this regard, the tool is coupled to a coiled, lightweight hose 12 connected, in turn, to a pressurized water supply.

With reference to FIGS. 3-6, and with further reference to FIG. 13, the shampooing tool 10 preferably has a so-called “clam shell” design. Accordingly, its housing 13 includes a pair of complementary mating sections (halves) 14 and 15, respectively, joined together along a common longitudinal midplane 16 (as shown more clearly in FIG. 13). The components of the tool 10 are mounted in the “bottom” section 14 of the housing 13, and the “top” section of the housing 13 constitutes a cover. When the mating sections 14 and 15 are secured together, the components of the tool 10 are trapped within the overall housing 13. As shown in FIG. 13, screws 17 pass through openings 18 in the top (cover) section 15 and are received in respective bosses 19 in the bottom section 14 of the housing 13. It will be appreciated, however, that other fastening means and indeed other housing designs may be used consonant with the teachings of the present invention.

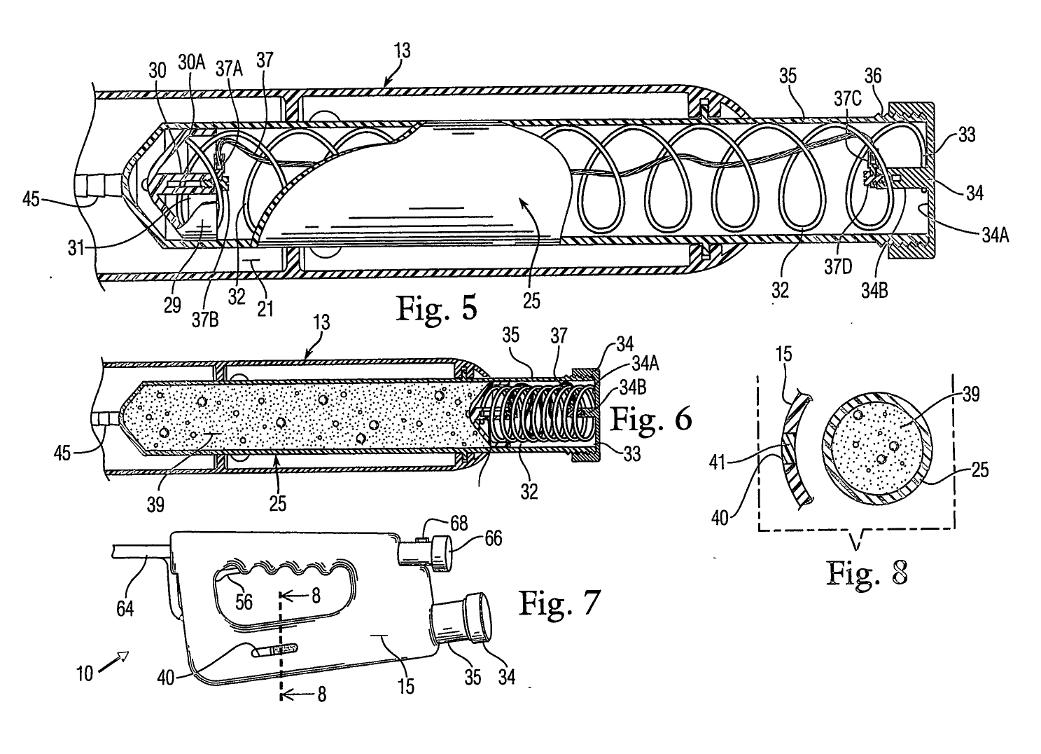

With this in mind, and with reference again to FIG. 3 and further reference to FIGS. 5-7, the housing 13 (when the respective sections 14 and 15 thereof are suitably joined together) includes an upper portion 20, a lower portion 21, a front portion 22 and a rear portion 23 joining the upper portion 20 and lower portion 21 to form, preferably, a completely enclosed hand grip 24.

A cylinder 25 is disposed within the lower portion 21 of the housing 11 and is trapped therein, both fore and aft. Preferably, the lower housing portion 21 has a semi-cylindrical boss 26 for cradling the cylinder 25 fore; and the cylinder 25 carries a ring 27 received in a similar (complementary) boss 28 in the housing 13, thereby cradling and positioning the cylinder 25 aft within the housing 13.

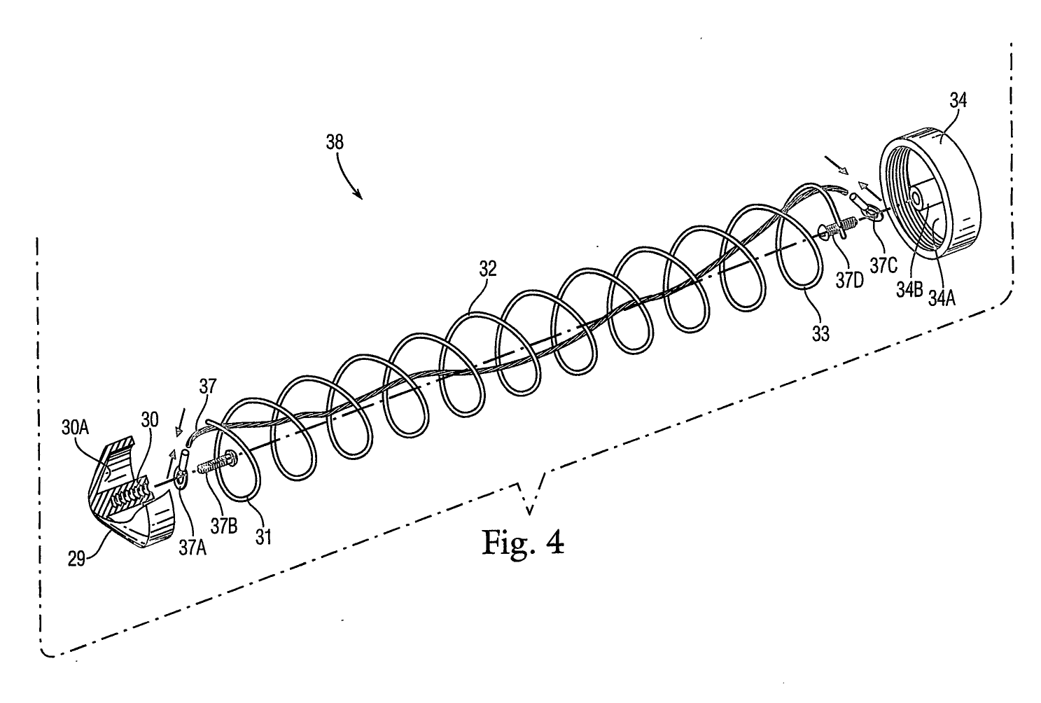

With reference again to FIG. 3, and with further reference to FIG. 4, a piston 29 is slidably received within the cylinder 25. Preferably, the piston 29 has an integrally-molded rearwardly-projecting central sleeve or boss 30, thereby forming an annular groove, well or trepan 30A within the piston 29. One end 31 of an elongated coil spring 32 is seated in the trepan 30A (and radially of the boss 30). The other end 33 of the spring 32 is seated in a trepan 34A (radially of a central boss 34B) in an end cap 34. This end cap 34 is carried by a rearward portion 35 of the cylinder 25 protruding rearwardly of the housing 13. Preferably, the rearwardly-projecting portion 35 of the cylinder 25 is externally threaded (as at 36) to receive internal threads on the end cap 34.

A lanyard 37 is connected between the piston 29 and the end cap 34. Preferably, the lanyard 37 comprises several strands of twisted wire, thereby forming a strong, flexible cable. One end of the lanyard 37 has a crimped-on eyelet 37A secured by a screw 37B to the central boss 30 on the piston 29. Preferably, the eyelet 37A is a conventional terminal used in the electrical arts. The other end of the lanyard 37 carries a similar crimped-on eyelet 37C secured by a screw 37D to the central boss 34B on the end cap 34.

The spring 32 is “free-floating” axially within the cylinder 25 (being confined radially therein) and is, in effect, “trapped” by the lanyard 37.

As a result, the piston 29, spring 32, end cap 34 and lanyard 37 form a complete subassembly 38 (see FIG. 9). This subassembly 38 creates a resilient bias on a reservoir of liquid detergent 39 within the cylinder 25, thereby pressurizing the reservoir 39 (as shown in FIG. 6).

With reference to FIGS. 7 and 8, a slot 40 is formed in one of the mating sections of the housing 13 (preferably within the top cover section 15) to receive a transparent window 41 for conveniently viewing the level of liquid detergent 39 remaining in the cylinder 25. As shown in FIG. 8, the cylinder 25 (or at least a portion thereof) is also made transparent.

With reference to FIGS. 9-12, replenishing the reservoir 39 of liquid detergent is therein illustrated. In FIG. 9, the subassembly 38 (of the piston 29, spring 32, end cap 34 and lanyard 37) has been removed from the shampooing tool 10. The tool 10 is then positioned (as in FIG. 10) for liquid detergent to be poured from a container 42 through a funnel 43 into the cylinder 25 in the tool 10. Thereafter, the subassembly 38 is re-inserted into the cylinder 25 in the tool 10 (FIG. 11) and the end cap 34 is tightened on to the rearwardly-projecting portion 35 of the cylinder 25 (as shown in FIG. 12) to thereby compress the spring 32 and again pressurize the reservoir 39 of liquid detergent in the tool 10.

With reference again to FIG. 3, and with further reference to FIGS. 13 and 14, the forward portion of the cylinder 25 has a discharge port 44 leading to a nipple 45. This nipple 45 carries an internal tube 46 joined to a nipple 47 which, in turn, leads to a valve seat 48. This valve seat 48 cooperates with a valve (or valve assembly) 49 disposed in the front portion 22 of the housing 13.

This valve 49 is positioned between complementary lands 49A and (like the cylinder 25) is trapped between the mating sections 14 and 15 of the housing 13. The valve 49 has a conical tip 50 normally seating on the valve seat 48 and resiliently biased thereon by a coiled spring 51 piloted on a stem portion 52 of the valve 49. Thus, the valve 49 is normally closed. The valve 49 carries two o-rings 53 for sealing purposes, and an upwardly-extending portion 54 of the valve stem 52 has a transverse slot 55 formed therein.

With reference again to FIG. 3, and with further reference to FIGS. 15-18, a trigger 56 is also trapped, preferably, within the complementary mating sections 14 and 15, respectively, of the housing 13. This trigger 56 has an integrally-molded main rib portion 57 piloted for limited sliding movement within two pairs of lands 58 and 59, respectively, within the housing 13 (as shown more clearly in FIG. 3). The trigger 56 further has an integrally-molded forwardly-projecting portion 60 received within the transverse slot 55 in the valve 49.

Accordingly, when the trigger 56 is actuated (as, for example, by being depressed within the enclosed hand grip portion 24 of the tool 10) the trigger 56 and valve 49 move in unison, against the resilient bias of the spring 51, to unseat the valve 49 from its valve seat 48. As a result, the pressurized liquid detergent 39 flows past the valve seat 48 around the valve 49 and into a nipple 61 extending out of the housing 13 (FIG. 3) and into a tube 62 disposed externally of the housing 13.

Preferably, and as shown in FIG. 3, the enclosed hand grip 24 of the housing 13 has a plurality of integrally-molded finger indentations 63 rearwardly of the trigger 56; such that the shampooing tool 10 of the present invention, besides being relatively lightweight and well balanced, is comfortable and convenient to use.

A barrel 64 is disposed in the upper portion 20 of the housing 13 (and preferably is suitably trapped therein). The barrel 64 has a portion 65 extending rearwardly of the housing 13 (see FIG. 21) for connection, via a suitable coupling 66, to the coiled hose 12 (shown in FIGS. 1 and 2). The coupling 66 (see FIG. 21) has a control means 68 for regulating the water flow from the coiled hose 12. One possible embodiment of the control means 68 comprised a knob 69 which can be moved between its “on” and “off” positions to control the quantity of water flowing out of the barrel 64. The coiled hose 12, in turn, may be connected to a standard garden hose 67 (FIG. 2).

In this preferred embodiment, the rearwardly-extending (female) portion 65 of the barrel 64 is internally-threaded, and the coupling 66 comprises a standard adapter having a male fitting to engage the female part of the extending portion 65 of the barrel 64. The other end of the coupling 66 has a female fitting for receiving the male part of the standard coiled or lightweight hose 12. (See FIGS. 1-3). The coupling 66 may be available from a local hardware store but, preferably, is supplied along with the shampooing tool 10.

With reference to FIGS. 19 and 20, and to FIGS. 22-24, the barrel 64 (for the water flow) and the external tube 62 (for flow of the pressurized liquid detergent 39) run substantially parallel to each other (see FIG. 20) and diverge (FIG. 22) at a shampooing head 70 carried on the respective forward ends of the barrel 64 and tube 62. The tube 62 and barrel 64 constitute a wand 71 for the tool 10 (see FIGS. 1 and 2). Alternately, the tube 62 may be disposed within the barrel 64 (FIG. 21).

The shampooing head 70 shown in the drawings is exemplary of various interchangeable implements or heads that may be mounted on the wand 71 (see FIGS. 23-27). With this in mind, and with reference to FIGS. 23-27, the shampooing head 70 has a plurality of suitable bristles 72 depending therefrom (FIG. 24). Interposed between the bristles 72 is a first set of orifices 73 (FIGS. 25 and 26). The shampooing head 70 is substantially hollow, as at 74, so that the first orifices 73 are in communication with the water flow through the barrel 64 (FIG. 24). A second orifice 75 as shown in FIGS. 25-27, (or a second set of orifices) is in communication with tube 62 through a canal 76 (FIG. 27) to facilitate flow of the pressurized liquid detergent 39 out of the shampooing head 70. The orifices 73 and 75 are independent of each other; and, preferably, the single orifice 75 for the liquid detergent (the soap) 39 assures that the soap will be used economically and sparingly and thus not unduly wasted. Indeed, the dispensing of the soap is independent of the water flow; it is completely under the operator's control and does not depend upon the water flow to aspirate the liquid soap out of its reservoir.

In order to soak, the water is turned on and the trigger is not actuated, so that no detergent is introduced. When the water is turned off and the trigger is activated, detergent (soap) is introduced. To shampoo, the water and trigger may be added or interrupted as desired and by movement of the shampooing head 70, the detergent is spread over the surface to be cleaned. The trigger is inactivated and water introduced to provide a rinse after the shampoo.

With reference to FIGS. 28-32, and in lieu of pouring the liquid detergent 39 into the cylinder 25 (per FIGS. 9-12), the subassembly 38 (comprising the piston 29, coil spring 32, lanyard 37 and end cap 34) is dispensed with; and a pre-packaged disposable cartridge 77 is employed. This disposable cartridge 77 (see FIG. 29) contains a reservoir 78 of liquid detergent under pressure and is slidably received within the cylinder 25 to abut against a needle 79 within the cylinder 25 (FIG. 30); and an end cap 80 is threaded or otherwise secured on to the rearwardly-projecting portion 35 of the cylinder 25. A coiled spring 81 is carried by the end cap 80 and pushes the cartridge 77 against the needle 79, such that the needle 79 pierces and/or ruptures a frangible seal 82 (see FIG. 32) on the forward portion of the cartridge 77 to allow the liquid detergent 78 under pressure in the cartridge 77 to flow through the needle 79 and to the valve 49 (for discharge, as at 62). The disposable cartridge 77, which may be sold in a “3 pack” or a “6 pack”, may be more convenient for the consumer.

With reference to FIG. 33, no cartridge is employed; and a suitable coupling 83 communicates through a hose 84 with a pressurized tank 85 of liquid detergent externally of the tool 10. This will be more economical, especially for a commercial dog-grooming or horse-grooming facility.

With reference to FIG. 34, the end cap 34 (in the FIG. 3 embodiment) is dispensed with and is substituted by a suitable coupling 86 to the pressurized tank 85.

The shampooing tool 10 of the present invention is not limited to use on dogs, horses and/or other animals but also finds use with humans. It is especially advantageous to use the tool 10 with persons P in nursing homes and ill people who cannot wash themselves, or can do so only with difficulty (FIG. 35). In this application the shampooing head 70 is designed to be compatible with humans and the bristles 72 are made of a material which does not irritate the person's skin. In place of bristles, the shampooing head 70 may have a plurality of spaced-apart bubbles or protrusions which contact the skin of the person (FIG. 37).

In use with humans it is preferred that the shampooing tool 10 has an external reservoir 78 of liquid detergent under pressure in a backpack 85 which is worn by the operator O. The backpack 85 includes a pump 86 powered by a motor 87 energized by a rechargeable battery 88. A flexible conduit 89 connects the pressurized liquid detergent reservoir 78 to the shampooing tool 10 (FIG. 36). In this configuration the operator O can shampoo and wash the person while the person is in a shower stall or other facility where the water and detergent run off is easily drained. The operator O has all of the supplies to efficiently shampoo the person P with no inconvenience to the person P and with minimum twisting, bending, stooping and strain on the operator O.

The shampooing tool 10 can also be used for cleaning a flat surface such as a wall 90 (FIG. 38). In this view the backpack is worn at the waist on the side of the operator to show the versatility of the configuration. The backpack could even be hung from a hanger on the wall.

To accommodate the several uses of the shampooing tool 10, the shampooing head 70 is formed with a removable and replaceable brush portion. As shown in FIGS. 39-43, the shampooing head is formed with a first casing 91 and an opposite second casing 92. The second casing 92 has a threaded stem 93 connected to the inner side at approximately the center of the second casing 92. The outer perimeter of the first casing 91 and the second casing 92 interface with a seal 93 therebetween to provide a watertight fitting. A body 95 having a plurality of bristles 72 formed on one face thereof is disposed in the second casing 92 with the bristles 72 protruding outwardly from a plurality of openings in the second casing 92. A centrally disposed opening is formed in the body 95 and the stem 93 is received in the opening when the head 70 is assembled. An opening is formed centrally in the first casing 91 and the stem 93 is received in the opening. A knob 96 having a central opening is disposed over the first casing 91 and the stem 93 is received in the opening. Preferably, the knob 96 has internal threads which cooperate with the threads on the stem 93 to secure the first casing 91 to the second casing 92 and to retain the body therebetween. The knob 96 may be a plastic molded wing nut. The barrel 64 and the tube 62 are connected to the first casing 91 and the water and liquid detergent are introduced through the barrel and tube respectively onto the body 95 and through the orifices 73 and 75. As previously explained, the water and detergent solution pass through the orifices.

The nature of the body 95 with the bristles 70 is determined by the use of the shampooing tool 10.

Accordingly, it will be appreciated that the shampooing tool 10 of the present invention meets all of its objectives and criteria, and has features and advantages heretofore not available in the prior art. The tool is lightweight, compact, well-balanced, sturdy, and ergonomically designed for easy and convenient use by the owners of dogs, horses or other animals as well as for use by professional groomers and also for use in humans. The operator of the tool has excellent control, independently, of both the water and the liquid detergent (the soap) for metering out the soap for best results, efficiently and economically. Besides its widespread commercial appeal, the shampooing tool of the present invention may be manufactured in volume and at relatively low cost for promotion and merchandising through various channels of marketing and distribution.

Additionally, for use with animals, the liquid detergent may incorporate a suitable fragrance and/or suitable insecticide especially for fleas or ticks.

Obviously, many modifications may be made without departing from the basic spirit of the present invention. For example, in lieu of the trigger 56, the valve 49 may be unseated by a battery-operated solenoid actuated by a push button on the tool (not shown herein). Further, the backpack may use a manually-operated hand pump in place of the battery-powered pump. Accordingly, it will be appreciated by those skilled in the art that within the scope of the appended claims, the invention may be practiced other than has been specifically described herein.

1-38. (canceled)

39. In a shampooing tool, the combination of a barrel connected to a pressurized water supply, a tube connected to a pressurized source of liquid detergent, the tube running substantially parallel to the barrel, the barrel having a forwardmost portion provided with a shampooing head, the shampooing head having a first set of orifices in fluid communication with the barrel and the pressurized water supply, the shampooing head further having at least one second orifice in fluid communication with the pressurized source of liquid detergent, and the respective first and second orifices being independent of each other.

40. The combination of claim 39, wherein the shampooing head has downwardly-projecting bristles intermediately of the respective first and second orifices.

41. The combination of claim 39, further including a housing having an upper portion enclosing an intermediate portion of the barrel.

42. The combination of claim 41, wherein the barrel has a rearward portion extending rearwardly of the housing and being connected to the pressurized water supply.

43. The combination of claim 42, further including a pivoted control valve on the rearward portion of the barrel.

44-47. (canceled)

48. The combination of claim 41 wherein a normally-closed spring-loaded valve is disposed in the housing, the valve normally being seated against a valve seat, and wherein a trigger is disposed in the housing, the trigger being connected to the valve for movement in unison; such that when the trigger is activated, the valve is inserted, and such that the pressurized liquid detergent flows into the tube for ultimate dispensing of the liquid detergent through the shampooing head.

49. The combination of claim 41, wherein the housing comprises a pair of complementary mating halves joined together along a common longitudinal midplane, and wherein the barrel, valve, and trigger are trapped between the complementary mating halves of the housing.

50-54. (canceled)

55. The method of shampooing a human, dog, horse or other animal using the combination of claim 39.

56-64. (canceled)

65. A shampooing tool, comprising a housing including an upper portion having a hand grip for the tool, the hand grip being provided with a trigger, the housing further including a lower portion having a conduit connected to an external reservoir of liquid detergent under pressure, the housing further having a front portion connecting the respective upper and lower portions of the housing, a spring-loaded normally-closed valve within the front portion of the housing, the valve seating against a valve seat connecting through the conduit to the pressurized reservoir of liquid detergent, the valve being coupled to the trigger for movement in unison; such that when the trigger is activated, the valve is inserted and liquid detergent passes through the conduit, past the valve seat, around the valve, and through a discharge port in the front portion of the housing, a tube connected to the discharge port and projecting inwardly of the housing, a barrel in the upper portion of the housing, the barrel having a rearward portion adapted to be connected to a pressurized water source, and a shampooing implement connected to the forward ends of the barrel and tube, respectively.

66. The shampooing tool of claim 65, wherein the external reservoir of liquid detergent under pressure comprises a pressurized tank.

67. The shampooing tool of claim 65, wherein the external reservoir of liquid detergent under pressure comprises a pressurized back pack.

68. The shampooing tool of claim 67, wherein the back pack includes a pump powered by a motor energized by a rechargeable battery.

69. The shampooing tool of claim 65, wherein the housing has a pair of complementary mating sections joined together along a common longitudinal midplane; wherein the trigger; and valve are mounted in one of the mating sections of the housing and wherein the other mating section of the housing comprises a cover secured to the one mating section.

70. The shampooing tool of claim 69, wherein the trigger includes an integrally-molded rib portion slidably mounted between respective pairs of lands formed in the one mating section of the housing.

71-84. (canceled)

85. In combination, a hand-held portable shampooing tool, the tool having a housing including a hand-grip portion, the housing having an upper rearward portion connected to a pressurized water source for discharge of water forwardly of the tool, the tool further having a lower rearward portion connected to an external pressurized source of liquid detergent for discharge of the detergent forwardly of the tool, and a trigger within the hand-grip portion of the housing for controlling the flow of liquid detergent independently of the water flow.

86. The combination of claim 85, wherein the external pressurized source of liquid detergent comprises a back pack having a pump powered by a motor energized by a rechargeable battery.

87. The combination of claim 85, wherein the external pressurized source of liquid detergent comprises a pressurized tank.

88. The combination of claim 85, wherein the shampooing tool has a barrel for the flow of water and further has a tube for flow of the liquid detergent, the barrel and tube extending forwardly of the tool, the barrel and tube terminating in respective end portions connected to an interchangeable shampooing head.

89-97. (canceled)
